(19) United States
(12) Patent Application Publication
(10) Pub. No.: US 2009/0130314 A1
(43) Pub. Date: May 21, 2009

(54) System for adhesion treatment, coating and curing of wood polymer composites

(76) Inventors: Bernard D. Bauman, Katy, TX (US); Kelly L. Williams, Loveland, OH (US)

Correspondence Address: SANFORD J. PILTCH, ESQ., 1132 HAMILTON STREET, SUITE 201, ALLENTOWN, PA, 18101, US

(21) Appl. No.: 12/313,416

(22) Filed: Nov. 19, 2008

Related U.S. Application Data
(60) Provisional application No. 61/003,822, filed on Nov. 20, 2007.

(51) Int. Cl. B05D 3/10

(52) U.S. Cl. 427/297; 427/372.2

(57) ABSTRACT

The present invention describes a system for modifying polymer composite surfaces to achieve 100% adhesion to paints, coatings, adhesives, or inks. The adhesion modification technology overcomes the deficiencies of energy-based treatment technologies common with wood-like polymer composites produced using various types of fillers and reinforcements, and specifically those containing cellulose and lignin.

### FIELD OF THE INVENTION

The present invention relates to wood-like products and, more particularly, relates to extruded, compression molded, or injection molded composites suitable for natural wood replacement and replacement for other plastics and composite materials. The invention relates to a process for effective substrate surface treatment of wood-like polymer composites such that any type of conventional or specialized coating technologies can be readily employed.

### BACKGROUND OF THE INVENTION

The present invention generally relates to composite mixtures of plastic and fillers, either bio-renewables such as wood, or inorganics. The invention more specifically relates to composites of wood fibers and thermoplastics known as Wood-Plastic Composites, which will sometimes be referred to subsequently as WPC. Wood-plastic composites are the combination of wood fibers, most commonly refined wood flour waste, and a thermoplastic such as high-density polyethylene (HDPE), polypropylene (PP), or polyvinylchloride (PVC). The polymer content is generally in the range of 30-70% by weight. WPCs are extruded into profile shapes via continuous extrusion, or injection or compression molded for the building and construction products industry as an alternative to wood and treated wood. The invention describes processes for improving the performance and appearance of WPCs by application of an oxidative surface modification step to enable a more comprehensive and chemically excellent adhesion of coatings, adhesives or decorative/protective systems to the surface.

The color of wood-like polymer composites is determined by a variety of factors. The choice and level of the reinforcing filler, the type of matrix polymer, any additives and pigments, and the extrusion or molding conditions all heavily influence the resultant color. Manufacturers of WPCs have gone to great lengths to control the color of fabricated products for applications such as decking, railing, siding, roofing, trim, doors, windows and other related building and construction products. Those familiar with the WPC marketplace understand that the longstanding inability to effectively paint or coat WPCs has created a strong belief that it cannot be done. The present invention demonstrates that any thermoplastic wood-like composite can be readily and cost-effectively adhesion treated for the application of any conventional or engineered paint, ink, coating, adhesive for structural assembly, or applying a decorative or functional wrap.

Historically, decking, fencing, railing and siding products have been fashioned from wood or treated woods. Solid wood composites are heavy and cumbersome to fabricate and install while also requiring significant attention over time to preserve and prevent decay. Splitting, rotting, mold and other outdoor weather-related factors cause homeowners to spend considerable time and money to preserve installed wood-based structures. Although natural wood products can be painted using conventional paints, WPCs are inferior for paint and other protective coatings adhesion. The best of both worlds would be a light-weight WPC that cuts and fastens like natural wood that will maintain its color for many years without the need for time consuming and costly preservation and without requiring staining, while resisting decay, rotting or warping.

Since the early 1990's, there has been an outstanding growth in the use of alternative wood-like composite products. However, the industry has yet to engineer a cost-effective solution for enabling wood-like composites to hold a decorative paint or protective coating. The color of wood-like polymer composites is determined by a variety of factors. The choice and level of reinforcing filler, the type of matrix polymer, any additives and pigments, and the extrusion or molding conditions, all heavily influence the resultant color. Specific deficiencies include color retention over time, scratch and mar resistance, mold, mildew and fungal attack, and the ability to be painted, sealed or stained effectively by the property owners. Exposure to ultraviolet light wavelengths and moisture absorption over time contribute substantially to the long-term degradation of WPC materials. The degradation predominantly involves aesthetics, with color fading and mold development, as well as losses in physical properties.

Even though wood is a naturally renewable resource, the availability of clear timber for producing sawn products presents a supply problem on a global scale. Using the waste materials of the timber industry, such as wood flour and fibers, a plentiful source of materials can be utilized for making alternative building and construction composites. Furthermore, WPCs have performance benefits superior to wood, such as resistance to termites, and resistance to warpage, cracking and splintering, and dimensional correctness.

The available sources for wood fibers can vary substantially, and, the sources for suitable polymers for manufacturing composites can range from virgin thermoplastics and thermosetting resins to recycled thermoplastics such as polyolefins. Existing techniques have demonstrated that wood and plastics can be effectively mixed in an extruder, or compression or injection molded. In addition to the wood-based by-products from the forest products industry, alternative sources of bio-based raw materials such as rice hulls, peanut shells, jute, paper, and the like have been demonstrated. For example, U.S. Pat. No. 3,908,902 [Collins, et al.], U.S. Pat. No. 4,091,153 [Holman], U.S. Pat. No. 4,686,251 [Ostermann, et al.], U.S. Pat. No. 4,708,623 [Kazuo, et al.], U.S. Pat. No. 5,002,713 [Palardy, et al.], U.S. Pat. No. 5,055,247 [Minora, et al.], U.S. Pat. No. 5,087,400 [Theuveny], U.S. Pat. No. 5,151,238 [Earl, et al.], U.S. Pat. No. 5,516,472 [Layer], U.S. Pat. No. 5,082,605 [Brooks, et al.], and U.S. Pat. No. 5,088,910 [Goforth, et al.] all relate to processes for producing wood-plastic composites.

To render wood-like composites, such as those made from polyolefins and wood fiber paintable, there must be an increase in surface energy of at least 45 dynes/cm. Traditional energy based methods such as corona or plasma discharge are not effective on such composites due to the cellulose and lignin content, as these serve as anti-oxidants. Flame treatment has been known to work albeit complex and lacking effective consistency. Charring with subsequent char removal can make such wood-like composites adhere to coatings, paints or adhesives. However, dusty environments such as the manufacturing of wood-like composites make the utilization of direct flame a fire and safety concern. In additional to safety concerns, energy-based treatments promote the degradation of the surface polymers that leads to a detriment of the strength of this molecular interface between the substrate and the coating, adhesive, or ink. Other oxidation techniques such as exposure to oxidative acids or ozone have difficulty in promoting increased surface energy because of the inhibitory effects of lignin.

In order for WPCs to be acceptable as substitutes for wood, it must be manufactured in specific shades and colors or be capable of being painted by consumers. Numerous attempts in the past to paint or coat these composites were not successful. Thus, the most common technology for imparting coloration to these composites is through the use of pigments melt-blended into the composite prior to molding. This causes the WPC to be colored all the way through the final product cross section. By using different types of pigments, WPCs can be made to appear similar to many different types of wood, such as cedar, redwood or oak.

Coloration of WPCs via pigmentation is problematic in several ways. For example, use of in-plant production scrap or post-consumer scrap is extremely challenging due to color management and control. Furthermore, with pigmented WPCs, over time and with exposure to sunlight and weather, the exterior surface becomes dull and chalky. Most commercial producers address this issue by stating that the installed composites become “rustic” looking much like an older wooden structure. Typically, outdoor WPC structures begin to discolor within the first 60-90 days post-installation.

Another approach that is used to decorate WPCs is co-extrusion. The most common co-extrusion method is to deposit a pigmented polymer layer onto the surface of the WPC substrate after it exits the die. However, it is commonly a challenge to get polymer-to-substrate adhesion, develop darker colors cost-effectively, and balance rheology to maximize production rates. This poses problems of requiring different equipment than that used to manufacture the more common polyolefin-based WPCs, which further increase the density and resultant weight of the final composite structure relative to traditional wood products.

Although WPCs help solve some of the industry problems with lumber, such as supply and some performance aspects mentioned above, there still remain glaring deficiencies of WPCs. For example, U.S. Pat. No. 6,758,996 [Monovoukas, et al.], assigned to Kadant Composites, describes a method to manufacture WPCs using papermaking sludge. Most WPCs are produced using polyethylene or polypropylene with dried hard or soft wood flour in ratios ranging from 30% to 90% wood content. These wood-like building products are typically extruded to profile shapes however compression molding and injection molding are quickly becoming common fabrication techniques.

Specifically, some WPCs suffer from fungal and mold attack; they lose their luster and gloss quickly, stain and scratch easily, and become extremely slippery when wet and hot when in direct sunlight. Fungal attack occurs when WPCs absorb sufficient moisture that fungus can grow on the cellulose (wood) particles near the surface. When fungus grows on the surface, it makes the surface appear dark and dirty. Once mold develops it is extremely difficult to remove causing repeated maintenance care in these mold-developing regions.

As a result, at least one earlier attempt to remedy the issue, described in U.S. Patent Application Publication No. 2006/0127433 A1 of Gohary, et al., explains the incorporation of anti-microbial and anti-fungal additives demonstrating the use of biocide additives that can be used in addition to pigments in the final WPC formulation. Another emerging method to alleviate moisture absorption is to use polymer coupling agents, such maleic anhydride-grafted polyolefins, to improve the bonding between the cellulose and the polymer matrix, thus improving the resistance to moisture uptake.

Many attempts have been made to improve the structural performance of these traditionally non-structural and semi-structural products. For example, U.S. Pat. No. 6,939,903 [Sigworth, et al.], assigned to Crompton Corp., teaches a way to treat cellulose when combined with the use of a grafted coupling agent results in an improved physical performance. Many studies have been done to demonstrate the added value of incorporating coupling agents into WPCs to enhance the compatibility and internal adhesion between the polymer matrix and reinforcement materials. One example is Wood Fibre Reinforced Polypropylene Composites: Effect of Fiber Geometry and Coupling Agent on Physico-Mechanical Properties, Applied Composite Materials, Vol. 10, No. 6, November 2003. Many suppliers offer engineered grafted polymer coupling agents such as Equistar Chemicals, Eastman, ExxonMobil, DuPont, and Crompton Corporation among others. Even though the use of coupling agents indeed improves the mechanical properties of WPC and improves the resistance to moisture related deficiencies, the use of coupling agents does not affect surface energy of the final molded or extruded composite for paint or coating adhesion.

Several additive technologies have also brought valuable benefits to WPC manufacturing. For example, various lubricant technologies have been developed to enable higher production rates of composite extrusion such as those taught in U.S. Pat. No. 6,942,829 [Ferro] and U.S. Pat. No. 7,151,125 [Lonza]. Combinations of coupling agents and other functional additives, albeit more costly, do improve the moisture-related deficiencies of most WPCs, especially those based on polyolefins and cellulose-based reinforcements and fillers.

As the WPC industry emerged, one of the more influential patents, U.S. Pat. No. 5,516,472 [Layer], assigned to Strandex Corporation, was one of the first teachings for how to extrude continuous high quality WPCs directly to final profile dimension thereby eliminating the need for milling and downstream fabricating. Another value-added improvement to the WPC industry is the ability to foam composites to give lighter weights such as that taught in U.S. Pat. No. 6,936,200 [Park, et. al.] for foaming WPCs.

WPCs manufactured from wood and polyvinyl chloride (PVC) is also a common type of wood-like composite. Even though PVC is denser than polyethylene or polypropylene, PVC has inherent polar functionality in the polymer backbone. Because of this, PVC and wood composites can be co-extruded with virgin pigmented PVC. Those knowledgeable in the art refer to this field of PVC-wood composites with PVC co-extrusion as “capstock” products. Examples of this can be found in U.S. Pat. No. 6,357,197 [Serino, et al], assigned to Andersen Corporation, and in U.S. Pat. No. 6,971,211 [Zehner], assigned to Crane Plastics. It would be desirable for existing WPC producers to be able to co-extrude or coat polyolefin-based composites, however, until the teachings of the present invention, it has not been sufficiently described or taught to enable a WPC that will retain its coloration and shape. In U.S. Pat. No. 6,078,713 [Blair, et. al.] a method for “printing” wood-like composites using a pressure printing drum to provide a plurality of depressions and deposition of inks or colorants is taught and is claimed to be suitable for any composite type regardless of formulation content. U.S. Pat. No. 7,097,879 [Bolton, et al], assigned to Grafted Coatings Inc., teaches the use of a staining kit for homeowners to stain and top coat wood-like composites, however, the method described is suited primarily for thermoset composites that have a much different matrix polymer that does not have the same deficiencies as most thermoplastic-based WPC. From the natural wood perspective, others have described methods for polymer coating wood products such as U.S. Pat. No. 7,175,905 [Curtis, et. al.], and U.S. Pat. Nos. 4,181,764 and 6,231,994, both granted to Totten.

Since the WPC decking market has grown since the early 1990s, the majority of manufacturers have ceased to promote their composite products as “No Maintenance” in change for “Minimal Maintenance”. As the producers have since recognized, WPCs are not resistant to moisture absorption that can cause mold development, decay, discoloration and can stain from food or grease spills. This requires the consumer to have to scrub or power wash their decks periodically, which is not what consumers want to do with a premium investment of wood-plastic composites over the competitive product, pressure treated wood. However, this invention allows decking and other WPCs to be purchased with a protective and decorative coating that will maintain much improved color fastness, resistance to scratching and marring, stain and mold resistance, and resistance to the build up of heat.

Through coating or painting wood-plastic composites, rather than the current technologies, several advantages are recognized. Firstly, compatibilizers and coupling agents are no longer required to reduce moisture sensitivity. Secondly, pigments are protected leading to long term color hold, or, pigments can be eliminated by either staining and clear coating, or top coated to any desired color. Thirdly, coating WPCs allows producers to use much improved levels of scrap that are currently unattainable due to color management issues related to current pigmenting practices. Furthermore, coating WPCs enable new technological benefits such as intumescent coatings, rock-like texturing, pattern printing, infrared/heat build mitigation, and other functional properties that are otherwise elusive or cost-prohibitive when incorporated into the bulk composite product.

The present invention solves the major deficiencies of WPC as described above, by employing a system which consists of performing a surface modification on the WPC followed by the application of an appropriate engineered coating. By applying a high performance coating, such as the aliphatic polyurethane systems used on automobiles, WPCs can be produced in any color and gloss level, with many years of projected durability and color hold. Appropriate coatings can provide outstanding scratch and mar resistance, as well as provide a surface that is easy to clean. Appropriate coatings can seal the WPC to prevent moisture absorption, mold growth, and physical property reduction. Using coating systems can also enable homeowners to repaint their WPC to match new decoration schemes, or repair scratches or mars over time of use.

The present invention overcomes many of the deficiencies in the field for producing high quality and long-lasting WPCs by enabling them to be decorated or protected via engineered paints or coatings. To overcome the lack of “coat-ability”, wood-plastic composite producers have incorporated sophisticated pigment concentrates to achieve wood-like appearances, hues, and colors using costly UV and oxidation mitigating additives. However, for polyolefin-based composites the color is known to fade. Furthermore, polyolefin-based composites remain vulnerable to moisture-related deficiencies such as mold and fungal development as well as stain development. A cost-effective and properly engineered method to apply a long-lasting coating would overcome these deficiencies, but such an adhesion system has yet to be technically achievable and is the focus of the current invention.

The present invention is also directed to be a simple extension of the current WPC industry, which has been in existence for decades. Those experienced in the field understand that WPCs can be produced from a variety of thermoplastic resins as a matrix for a variety of reinforcements and fillers including, but not limited to, wood flour, wood-based fibers, jute, kenaf, sisal, rice hulls, peanut shell hulls, plant fibers, bamboo fiber, palm fiber, sugar kane bagasse, hemp, coconut coir, flax, cotton fibers, wheat pulp, paper, cardboard, and recycled wood composites such as wood veneer.

To render WPCs, such as those made from polyolefins or PVC and wood fiber paintable, there must be an increase in surface energy of at least 45 dynes/cm. However, even that level of surface energy is not sufficient for excellent adhesion if the surface does not have chemical properties that facilitate adhesion bonds between the coating and the surface. Traditional energy based methods such as corona and plasma discharge are not effective on such composites due to the cellulose and lignin content. Flame treatment has been known to work albeit complex. Charring with subsequent char removal can make such WPCs adhere to coatings, paints or adhesives. However, dusty environments such as the manufacturing of WPCs make the utilization of direct flame a fire and safety concern. Other oxidation techniques such as exposure to oxidative acids or ozone are believed to promote increased surface energy, however these treatment options are costly possessing their own concerns of safe implementation. Thus, the preferred surface modification method in the present invention utilizes a reactive gas atmosphere that consists of, at least in part, elemental fluorine (F₂) and oxygen (O₂) gases that render the surface of WPCs paintable, followed by application of a paint or other coating.

There are additional attributes of the fluoro-oxidation process that make it ideal for this application. One major attribute is that the surface modification is permanent. There is a small amount of cross-linking at the surface that helps stabilize oxidation groups from rotating into the first several molecular layers, which is common with other treatment methods that fade after days or weeks. Another attribute is that the chemistry is extremely rapid and the process window is wide, which means that it is a robust, low cost operation that does not require sophisticated control systems and highly trained personnel. Since the oxidation occurs in less than one second, the process can be done in-line as well as in an off-line operation at rates greatly exceeding current WPC extrusion rates. Since the process only modifies the outer few molecular layers, there is no visible change in topography. Thus, embossed patterns are unaffected. Recycling of treated composites is also of no concern. Moreover, the technology works well on WPC made any combination of polymer and bio-based filler material.

The present invention overcomes many of the deficiencies in the field for producing high quality and long-lasting WPCs by enabling them to be decorated or protected via engineered paints or coatings. To overcome the lack of “coat-ability”, WPC producers have incorporated sophisticated pigment concentrates to achieve wood-like appearances, hues, and colors. However, for polyolefin-based composites the color is known to fade. Furthermore, polyolefin-based composites remain vulnerable to moisture-related deficiencies such as mold and fungal development as well as stain development. A cost-effective and properly engineered method to modify the surface of WPC to facilitate application and excellent adhesion of long-lasting coating would overcome these deficiencies, but such a system has yet to be technically achievable and is the focus of the current invention.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a chemical reaction mapping for the fluoro-oxidation of polyethylene according to the adhesion system of the present invention.

FIG. 2—is a diagrammatic depiction of the wetting performance of the adhesion process of the present invention.

FIG. 3 is a series of photographs of the “Tape Test Results” of the ASTM D-3359 testing of several coatings tests using the adhesion system of the present invention.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description, taken in conjunction with the accompanying drawings.

The present invention is directed at wood-like composites, such as composites of a thermoplastic and organic fillers such as refined wood flour, called WPCs that inherently lack sufficient surface energy to be painted, coated, printed or adhesively bonded to. The present invention is more specifically directed toward polyolefin-based WPC building products whereby such a surface energy solution brings widespread market value. The present invention describes a reactive gas treatment that quickly and effectively oxidizes the surface of the WPC and facilitates tenacious adhesion, especially to performance-based coatings.

The WPC that can be used for this invention can be any combination of thermoplastic or thermoset polymers with any bio-based or inorganic filler such as wood flour, flax, rice, hulls, straw, paper, wheat, ash, talc, carbonates, etc. The polymers useful in such WPCs include polymers, copolymers, and terpolymers formed from ethylene, propylene, butylene, vinyl chloride, styrene, etc. It is preferable to use the polymers in the range from 20-80 wt %, and more preferably from 35-55 wt %. Preferably, the composite consists of polyethylene, polypropylene or PVC with refined hard or soft wood flour. The combination of polyolefins or vinyl plastics with cellulosic by-products constitutes the largest and most diverse field of composites used in industry.

WPC products can be made from a number of thermoplastics such as polyethylene, polypropylene, polyvinyl chloride [PVC], polyethylene glycol, polycarbonate, acrylic butadiene styrene [ABS] and mixed recycled plastics, as well as a number of thermoset polymers such as epoxy, polyurea, polyester, polyurethane, etc. Cellulosic by-products and other organic fillers such as wood flour, saw dust, flax, straw, wood fibers, jute, kenaf, rice and wheat hulls can be used to complete the product, as well as certain inorganic materials such as talc or calcium carbonate.

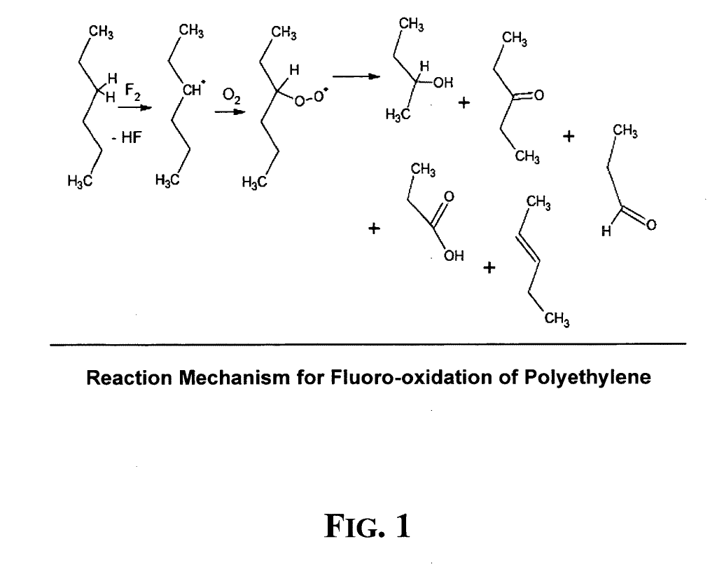

The process to oxidize the WPC in the present invention uses elemental fluorine as an initiator for the permanent oxidation of the composite surface. Our understanding of the reaction mechanism for fluoro-oxidation of polymers such as polyolefins is that it begins with a fluorine atom abstracting a hydrogen atom from the carbon backbone to create a carbon radical. Once the carbon radical is formed, kinetically favored oxygen preferentially reacts with the carbon radical forming a peroxy radical. Peroxy radicals subsequently undergo various reactions to form hydroxyl, carboxy, and other polar functionalities. FIG. 1 illustrates the fluoro-oxidation chemistry for the surface reaction process when WPC is treated with fluorine and oxygen.

The WPC will have at least one surface oxidized via exposure to a reactive gas atmosphere or reactive liquid consisting of F₂, Cl₂, O, O₂, O₃, SO₃, oxidative acids, or mixtures thereof, at a temperature, pressure, and residence time sufficient to increase the surface energy of the surface being modified to at least 45 dynes/cm at a temperature of 20° C. More preferably, the reactive atmosphere will consists of F₂ and O₂ gases with a diluent gas. The reactive gas atmosphere used in this invention ranges from 0.1%-20% F₂ (by volume), 2%-99% O₂ (by volume) and the remaining components being a diluent gas such as nitrogen (N₂) or carbon dioxide (CO₂). This process clearly demonstrates that exposure to reactive gas environments made up of elemental fluorine, oxygen and diluent gases robustly increase the WPC surface energy above 45 dynes/cm, and more preferably above 50 dynes/cm.

During the adhesion enhancing process of the present invention, the WPC products are exposed to the reactive gas atmosphere continuously or in batch-wise processes. The exposure time required to render the wood-plastic composites paintable ranges from <1 second to >1 minute, and more preferably, from 1 second to 10 seconds. The exposure time required for increasing the surface energy can be as low as 0.2 seconds with no detrimental effect on the substrate if exposure times are increased to excess of one hour. The invention also shows that practically any concentration of elemental fluorine for any amount of exposure time effectively renders the WPC to strongly adhere and bond to paints, coatings, inks, or adhesives. The exposure method can be batch-wise, such as for injection or compression molded parts, or as a continuous process for substantially linear parts, such as extruded decking boards. Once the composite surface is treated, most any coating or paint can be applied to the oxidized composite surface resulting in a 4B to 5B adhesion rating using ASTM D3359B Cross Hatch Test.

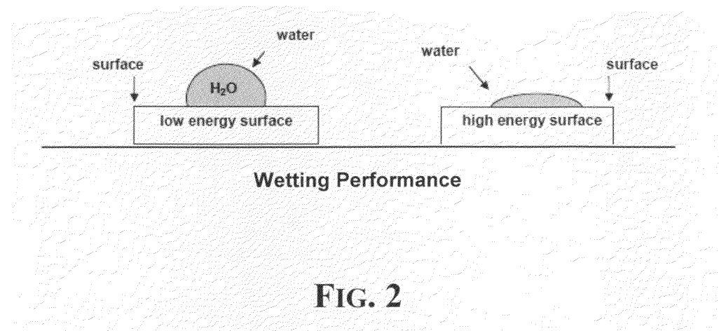

The creation of polar functional groups during fluoro-oxidation facilitates wetting of the WPC surface with a coating liquid. Improved wetting enables coating liquids to thoroughly and intimately associate with the WPC surface. A higher surface energy means greater interaction between the coating liquid and the substrate surface, as illustrated in FIG. 2. TABLE 1, presented below, summarizes the change in water contact angle and surface energy caused by fluoro-oxidation of a wood-product composite sample.

TABLE 1

| | WATER | SURFACE |
|---|---|---|
| | CONTACT | ENERGY |
| | ANGLE¹ | [dynes/cm] |
| UNTREATED WPC | 100.5° | 22 |
| FLUORO-OXIDIZED WPC | 30.4° | 64 |

¹Dr. Marie Laborie, Washington State University

The presence of polar groups on the surface is also important because they provide sites for strong adhesion through a variety of bonding mechanisms ranging from hydrogen bonds to covalent bonds. Testing has shown that fluoro-oxidation of WPC substrates resulted in excellent adhesion of many types of conventional and UV-curable coatings. The coatings industry standard test for coating adhesion is ASTM D-3359 which test provides for the coating surface to be cut using a sharp blade cutting device to produce a series of crosshatched markings through the coating thickness. Then a standard dimensioned tape is pressed onto the cross-hatched cut area and removed. Based upon the amount and distribution of coating pulled from the surface and adhered to the tape a rating is derived.

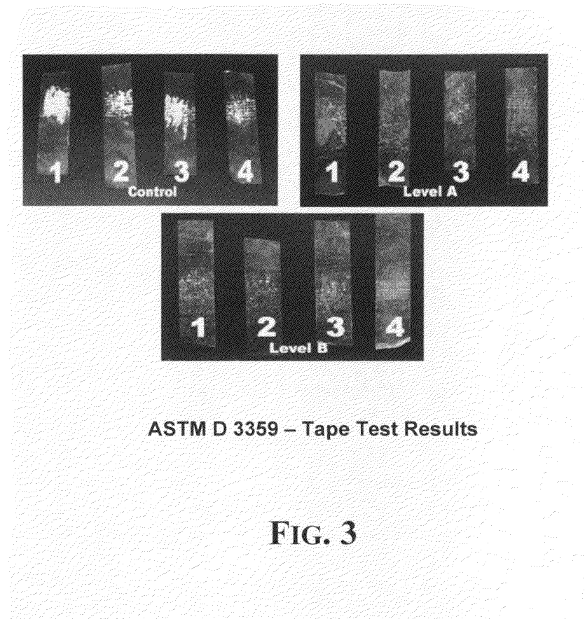

Initial experiments using ChoiceDeck® brand railing products from A.E.R.T., Inc. of Springdale, Ark. and Strandex® composites from Strandex Corporation in Madison, Wisc. were undertaken. Seven different paints were utilized on two variations of fluoro-oxidation: moderate and aggressive. The difference between moderate and aggressive treatment conditions, in this experimentation, is the concentration of fluorine was doubled for the aggressive conditions. FIG. 3 shows the results from the pressed and removed tape strips from the Control to the two variations of fluoro-oxidation. TABLE 2, presented below, provides a correlation between and among the results of the two fluorine concentrations and the applied coatings.

TABLE 2
ASTM D-3359 - CROSS-HATCH ADHESION TESTING RESULTS

| | TREATMENT | TREATMENT | | |
|---|---|---|---|---|
| COATING TYPE | CONDITIONS A | CONDITIONS B | CONTROL | WPC TYPE |
| Zinsser Pre-wall Covering | Strong | Strong | Poor | C-Deck |
| Primer | | | | |
| Glidden Interior/Exterior Latex | Very Strong | Very Strong | Weak | C-Deck |
| Enamel | | | | |
| Kilz Latex Interior/Exterior | Strong | Strong | Poor | C-Deck |
| Water-based Paint | | | | |
| American Tradition Exterior Oil | Very Strong | Very Strong | Weak | C-Deck |
| Primer | | | | |
| DuPont IMRON ® 1.5 ST-D ™ | Very Strong | Very Strong | Weak | Strandex |
| Satin Waterborne PU | | | | |
| Copolymer | | | | |
| DuPont IMRON ® 1.5 ST-D ™ | Very Strong | Very Strong | Modest | Strandex |
| Satin Gloss PU (solvent-borne) | | | | |
| Finished Unlimited - | Very Strong | Very Strong | Modest | Strandex |
| Developmental Acrylic Latex | | | | |

Achieving an effective surface modification is only part of the solution to the deficiencies of WPC. It is also necessary to select the right coating system that meets all of the performance requirements for specific applications, as well as being economical. It is noteworthy that WPC profiles for different applications have totally different coating coverage requirements. For example, for siding applications, only the top and sides of the boards need be coated, whereas in other applications the entire board might be required to be coated.

Several polymer systems, as well as hybrid systems, can be used to create coatings. Each system provides a unique set of performance characteristics, has unique application/curing requirements, and unique economic factors. Coatings economics are determined by many factors including costs of coating resins, solvent (VOC) abatement, coatings application methods, efficiency of coating usage (overspray losses), space requirements, cure energy (drying) requirements, and capital costs.

From the WPC producer's perspective, there are several options for using a system to adhesion treat, paint (coat), and cure WPC products. Since the WPC extrusion process is an inherently linear process, adding the fluoro-oxidation adhesion treatment and coating/curing processes can be added in-line. Depending on the coating type and curing method, the process can run anywhere from 10 fpm to >100 fpm. Since the average WPC extrusion process operates at 8-15 fpm, the adhesion treatment and coating/curing process could be under utilized. There are advantages to operating the process out-of-line with an extruder. For example, several extrusion lines can share a single source of reactive gas that would enable WPC lines to employ multiple coating types and curing methods.

Since the adhesion treatment is permanent, coating operations can be done at the WPC extruder's location, on a toll-basis by another firm, or shipped to other producer's locations for final coating application, printing, or adhesive assembly. In this manner boards or profiles are fed continuously as cut stock into the process. Using conventional paints and coatings, the maximum line speeds are estimated at 30-50 fpm employing infrared curing. Even though conventional paints are low cost, they do present potential limitations. One issue is being able to repack and bundle boards immediately after curing. With conventional paints and coatings, there is a reasonable potential of film blocking. A more substantial limitation is being able to coat all sides of the board or profile in a single pass, which is desirable for both decking and railing products. Of course, WPC boards or profiles can be coated in multiple stages for applications requiring full surface coverage using conventional curing methods, however capital requirements and process floor space would need to be incrementally larger.

Preferably, the paint or coating is made of conventional water-based acrylics or solvent-borne oil derived, but more preferably the coating is made of UV curable 100% solids paints. Recognized benefits of UV are the ability to cure within seconds using lower cost equipment and much less floor space than conventional coating systems. Assuming the WPC being coated is long enough to coat and extend into a curing chamber where a bottom side lamp cures the area prior to reaching the supporting roller or belt, the entire encapsulation process is capable of running in excess of 100 fpm. There are several important benefits to UV over conventional air-dried or infrared cured systems. First, The UV coating/curing can operate at line speeds in excess of 100 feet/minute, well above the current line speeds of typical industry extrusion lines producing WPC lineals. The completeness of curing allows immediate repacking of coated WPC products without concern for blocking or smearing of the applied coating.

The mechanism by which elemental fluorine oxidizes the polymer surface is by way of the creation of a plurality of carbon radicals. These carbon radicals are formed via hydrogen abstraction from the polymer backbone thereby creating HF gas which is easily swept and removed via exhaust alkaline scrubbers. In the absence of oxygen, eventually a fluorine atom will graft onto the carbon radical creating a C—F bond. But in the presence of molecular oxygen, which is a much favored kinetic rate of reaction with the carbon radical, oxidation takes place. The formation of hydro-peroxy radicals, carboxylic acids, ketones, and other carbonyl moieties are generated. Due to this mechanism being a true gas-to-solid reaction with no high energy ablation of surface polymer molecules, the negative consequence of surface energy fading over time from chain mobility and weakening of the interfacial layer by molecular weight reduction is not present. Therefore, the surface energy is stable enough to endure packing and transporting prior to painting or coating as long as caution is taken to ensure the oxidized molecular layers are not abraded in the process.

Once the WPC is adhesion modified, the substrate can be immediately painted or coated using any conventional coating material and cured using any conventional means. Or, the WPC can be printed, such as to produce real-wood grain patterns, or adhesively assembled such as for furniture construction. It is preferable that articles and profiles of WPCs are fed continuously by an integrated, conveyor-fed system into the reactive gas atmosphere followed by a standard spray chamber or vacuum coater then further into a curing chamber of high intensity UV light.

The preferred process for oxidizing WPC articles or profiles is in a chamber that continuously feeds the articles or profiles via a conveyor. The chamber is designed to maintain a slight vacuum such that delivered reactive gases are safely removed and scrubbed using alkaline neutralizers and is open at the front and back to allow the profiles to pass through. At the approximate middle of the treatment chamber the oxyfluorination treatment is performed on the WPC profiles by exposing the profiles to an atmosphere of F₂, O₂ and inert gas mixtures. The treatment chamber is preceded and followed by associated vacuum scrubber chambers where substantially all of the ambient gas is pulled into the treatment chamber to prevent any fluorine, or other toxic gas, from flowing out into the workplace. The articles or profiles that exit the treatment chamber possess an oxidized surface of no less than 45 dynes/cm that is considered to be substantially stable over time. The treated articles or profiles are then fed into a device capable of coating specific sides, or all sides of the fed composite. Generally, the coatings will be pigmented so as to add color, or, be used to apply a protective clear coat, or as a primer coat.

The preferred system for coating all sides of a WPC shape, in a single coating pass, is to use a flat line UV curable system. In this preferred design, the profile is fed continuously into a 100% solids UV spray system with overspray reclaim, roll coater, or a vacuum coater. The bottom of the profile is exposed to a UV curing lamp to solidify the bottom of the profile just prior to the substrate reaching a support or conveyor section. In series, the remaining coated sides are cured using pertinent UV curing lamps. There are several important benefits to UV over conventional air-dried or infrared cured coating systems, which are:
1. UV coating/curing can operate at line speeds in excess of 100 fpm, well above the current line speeds of wood-like composite extrusion;
2. The completeness of curing allows immediate repacking of coated wood-like composite products without concern for blocking or smearing of the applied coating;
3. 100% UV curable coatings are environmentally friendly producing no VOC emissions or hazardous waste chains;
4. UV coating technology producing a highly cross-linked polymer network after light exposure which fundamentally provides the basis for durability and toughness; and,
5. UV curable coatings can easily be tailored for hardness, gloss, flat, flexibility, weatherability, etc. allowing virtually any property to be engineered.
   An alternative preferred system for coating utilizes 100% solids, two-component reactive cure chemistries. These can be formulated in a broad range of physical properties and colors, and can be designed to cure in the range of less than one second to several minutes. Examples of amenable two-component systems include polyurethane and polyurea. The down side of loss of coating material due to over spray is off set by reduced capital and energy requirements.

There are advantages to conventional solvent and waterborne coatings however. Conventional coatings are generally lower cost, can be applied in thicker coats (>2.5 mil) and are available in a much broader array of colors, hues and textures. Conventional coatings can be applied by spraying, brushing, rolling, vacuum coating or flow coating using relatively low cost equipment and curable using forced convection ovens or infrared radiation. Depending on the marketplace need, any suitable coating, application method and curing method can be readily amenable using the elemental fluorine-based adhesion treatment aspect of this invention. The coating can be a clear coat that provides weathering protection to pigmented WPCs, provide scratch and abrasion resistance or other “protective” performance elements. The coating can also be pigmented, colored or textured using colorants and additives to achieve both durable protection as well as aesthetic qualities. For example, scrap pigmented WPCs cannot easily be recycled into virgin composite production due to inability to manage the resultant color. By employing this invention, scrap WPCs can be manufactured with engineered paints for the building products and home and garden markets. By employing the system of the present invention, scrap WPCs can be manufactured with engineered paints for building products and home and garden markets.

### EXAMPLE 1

In this Example, a commonly available PE-based wood-polymer composite, trade named ChoiceDek™ from A.E.R.T. of Springdale, Ark. was purchased from an authorized distributor/reseller. Half of the composite pieces were treated for 5 minutes using a low elemental fluorine concentration and the other half was treated for 5 minutes using a much higher fluorine level. Including untreated controls, all pieces were coated at approximately 1 mil using a standard painting brush. The paints used are listed in TABLE 3 along with the adhesion test results using a recognized Cross-Hatch Adhesion Test—ASTM D-3359-B.

TABLE 3
CROSS-HATCH ADHESION TEST - ASTM D-3359-B

| | Low | Low | NO |
|---|---|---|---|
| PAINT DESCRIPTION | [F₂] | [F₂] | TREATMENT |
| Zinsser pre-wall covering primer | 4B-5B | 4B-5B | 0B-2B |
| Glidden interior/exterior latex enamel | 4B-5B | 4B-5B | 0B-2B |
| Kilz latex interior/exterior | 4B-5B | 4B-5B | 0B-2B |
| water-based | | | |
| American Tradition exterior | 3B-4B | 3B-4B | 0B-2B |
| oil primer | | | |

NOTE:
The higher the “B” rating, the greater the adhesion with 5B being the highest result.

### EXAMPLE 2

In this Example composite boards were supplied by Strandex Corporation of Madison, Wisc. and modified for adhesion using similar fluorine concentrations as in Example 1. The results of the testing are shown below in TABLE 4.

TABLE 4
CROSS-HATCH ADHESION TEST - ASTM D-3359-B

| PAINT DESCRIPTION | TREATED | UNTREATED |
|---|---|---|
| DuPont IMRON ® 1.5 ST-D ™ | Excellent | No Adhesion |
| Satin (water-borne) | | |
| DuPont IMRON ® 1.5 ST-D ™ | Superior | Some Adhesion |
| Satin gloss (solvent borne) | | |
| Development high solids waterborne | Superior | Little Adhesion |
| acrylic latex (from Finishes Unlimited, | | |
| Sugar Grove, IL) | | |

### EXAMPLE 3

In this Example Strandex composites and Stancell™ foamed PE/wood composites were treated for adhesion similarly to Examples 1 and 2. The samples were then coated with various combinations of clear and colored 100% solids UV-curable paints supplied by Finishes Unlimited, Sugar Grove, Ill. The UV paint standards for the Finishes Unlimited UV-curable paints are detailed in TABLE 5 set out below.

TABLE 5

| | |
|---|---|
| Gallon Wt (+/−0.2 lbs) | 9.26 |
| Weight Solids | 100% |
| Volume Solids | 100% |
| Viscosity #4 Zahn @ 77° F. | 50″-60″ |
| VOC (sans water) | None |
| VOC as supplied | None |

The cured film properties are presented in Table 6 below.

TABLE 6
CURED FILM PROPERTIES
[at 1 mil on Adhesion Treated Strandex]

| | |
|---|---|
| 60° Gloss [ASTM D-523] | 85+ units |
| Adhesion [ASTM D-3359] | Excellent |
| Freeze Resistance, 96 hrs @ 20° F., −25° F. | No Effect |
| Adhesion [ASTM D-3359] | Excellent |
| Heat Resistance, 144 hrs @ 120° F. | No Effect |
| Adhesion [ASTM D-3359] | Excellent |
| Flexibility/Impact Resistance¹ | Excellent |
| Immersion Testing, 48 hrs in | No Effect |
| Olympic Premium Deck Cleaner | |
| QUV Weathering Test [ASTM G-154], cyclical | 1,000 hrs |
| 4 hrs UV Light/4 hrs condensation | |
| Gloss Retention (85° meter) | 70% |
| Color Change (ΔE CIELAB) | 1.35 units |
| Repaint Adhesion (lightly sanded and | Excellent |
| repainted w/Behr Porch &Floor Paint) | |

¹Coated and cured board was aggressively impacted with various hammers showing no breakage of the coating film

The paints or coatings can be applied via traditional systems such as dip coating, curtain coating, spray coating, vacuum coating or roller applied systems. Curing of the paint or coating can be from heated air from convection ovens, infrared or UV light. UV cured paints or coatings are preferred due to the high solids, faster line speeds, fast and efficient curing as well as the nonexistence of hazardous volatile organic compounds (VOC's).

One hundred percent (100%) UV curable coatings are environmentally friendly producing no VOC emissions, thus no volatiles or hazardous waste streams. UV-curable coatings are much more costly on a per gallon basis versus conventional waterborne coatings, yet many companies that have made the conversion are still recognizing net economic benefit with greater flexibility and performance. Many producers of fabricated wood products have made the switch from clear solvent-borne coatings to UV clear coats. UV clear coats are also prevalent in exterior automotive plastic components and many types of rigid and flexible packaging. The introduction of pigmented UV-curable paints is now emerging as formulations are being developed that permit full penetration of UV light. UV coating technology is beginning to develop for commercial scale pigmented coatings that can be as easily cured similar to clear coats. One of the more recognized benefits of UV-curable coatings is the ability to cure within seconds. Lastly, UV curable coatings can easily be formulated for hardness, gloss, flexibility, chemical resistance, weatherability, etc. allowing virtually any property to be engineered. The TABLE below provides details of the performance results of the developed coating applied to Strandex® boards.

TABLE 7
UV-CURED PAINT PERFORMANCE RESULTS

| | | CURED FILM PROPERTIES | |
|---|---|---|---|
| LIQUID PAINT STANDARDS | | [at 1 mil on Fluoro-Oxidized Strandex ®] | |
| Gallon Wt (+/−0.2 lbs) | 9.26 | 60° Gloss ASTM D-523 | 85+ units |
| Weight Solids | 100% | Adhesion ASTM D-3359 | Excellent |
| Volume Solids | 100% | Freeze Resistance | No Effect |
| | | 96 hrs @ 20° F., −25° F. | |
| Viscosity #4 Zahn @ 77° F. | 50″-60″ | Adhesion ASTM D-3359 | Excellent |
| VOC (sans water) | None | Heat Resistance | No Effect |
| | | 144 hrs @ 120° F. | |
| VOC (as supplied) | None | Adhesion ASTM D-3359 | Excellent |
| | | Flexibility/Impact Resistance | Excellent |
| | | Immersion Testing | No Effect |
| | | 48 hrs immersed in Olympic | |
| | | Premium Deck Cleaner | |
| | | QUV Weathering Test ASTM G-154 | 1000 hrs |
| | | (Cylindrical 4 hrs UV Light/4 hrs | |
| | | Condensation) | |
| | | Gloss Retention (85° meter) | 70% |
| | | Color Change (ΔE CIELAB) | 1.35 units |
| | | Repaint Adhesion | Excellent |
| | | Lightly Sanded, Repainted w/Behr | |
| | | Porch &Floor Paint | |

As can be determined from TABLE 7 above, the UV-curable coating developed for WPC substrates provides an excellent balance of toughness, weathering, and chemical resistance. This coating was developed for outdoor decking and flooring substrates. Due to the weathering performance, ability to tailor gloss and color, the same coating system is ideal for railing and siding products. For applications such as siding, the performance requirements would likely dictate a different formulary approach since mar and abrasion resistance is not as critical as color retention, weathering and re-paintability. Furthermore, the siding market shows a greater preference for primed panels that are engineered for painting at the construction sight.

There is a noted correlation between oxygen on the surface of WPC products and the adhesion of coatings. It has been noted in the literature that surface energy measurements on WPC do not correlate well with adhesion to coatings, as described in “Surface properties and adhesion of wood fiber reinforced thermoplastic composites”; B. Gupta, et al., Colloids and Surfaces A: Physicochem. Eng. Aspects 302 (2007) 388-395. This is believed to be a result of surface energy being defined by different physical and chemical traits than those that determine the strength of bonds between substrates and coatings. When WPC is molded, the very outermost surface, the outer few molecular layers, substantially consist of the added thermoplastic composition. It is the interaction of this extremely thin layer of thermoplastic with subsequently applied coatings that determines the adhesion strength of the coating bond. All known analytical techniques, including Fourier Transform Infra Red Spectroscopy (FTIR) and X-ray photoelectron spectroscopy (XPS), produce an analysis of some degree of depth into a surface and provide indication of a sort of average composition instead of indicating what is only on the surface. This analysis complication is a major problem for analyzing the true surface composition of WPC because the analytical techniques sample through the thin thermoplastic layer and provide results that include contributions from the wood and other additives below the surface.

Therefore, to study which characteristics are truly important in providing excellent adhesion to WPC composites, we began by studying unfilled thermoplastics typically used in the manufacture of WPC. In these studies it was discovered that the amount of oxygen incorporated in a surface during adhesion treatment, as measured by XPS, is the best predictor for adhesion to coatings.

### EXAMPLE 4

A number of samples of three types of thermoplastic were surface modified by treatment with fluorine-containing atmospheres under vastly different treatment conditions in terms of fluorine (F₂) concentration, oxygen (O₂) concentration, and exposure time. All treatments were performed at ambient temperature. These treatments were performed in a batch reactor with interior dimensions of approximately 2×2×3 ft. Following the various treatments, representative samples from each treatment condition were analyzed via XPS. The instrument used was a PHI 5000LS ESCA Spectrometer. The conditions for the analysis were: Excitation source: Mg Kα radiation, 15 KeV, 300 watts; Analysis diameter 1.1 mm; Take-off angle 45°; and Pass energy: Survey scan 89.45 eV. Only the oxygen content of the surfaces is reported in this data since it was the only independent variable that correlated well with adhesion strength. The treatment conditions and the resulting oxygen content on the surfaces are summarized below in TABLES 8, 9 and 10.

TABLE 8
HIGH DENSITY POLYETHYLENE

| | F₂ (volume %) | O₂ (volume %) | Time (seconds) | O via XPS |
|---|---|---|---|---|
| | 0 | 21 | — | 2 |
| 1 | 0.05 | 2 | 2 | 3 |
| 2 | 0.5 | 10 | 2 | 8 |
| 3 | 1 | 10 | 1 | 8 |
| 4 | 5 | 8 | 2 | 13 |
| 5 | 10 | 10 | 1 | 14 |
| 6 | .5 | 0 | 1200 | 2 |
| 7 | 2.5 | 0 | 1200 | 1 |
| 8 | 5 | 10 | 1200 | 16 |

TABLE 9
POLYPROPYLENE

| | F₂ (volume %) | O₂ (volume %) | Time (seconds) | O via XPS |
|---|---|---|---|---|
| | 0 | 21 | — | 4 |
| 1 | 0.05 | 2 | 2 | 4 |
| 2 | 0.5 | 10 | 2 | 9 |
| 3 | 1 | 10 | 1 | 8 |
| 4 | 5 | 8 | 2 | 15 |
| 5 | 10 | 10 | 1 | 16 |
| 6 | .5 | 0 | 1200 | 4 |
| 7 | 2.5 | 0 | 1200 | 4 |
| 8 | 5 | 10 | 1200 | 16 |

TABLE 10
POLYVINYL CHLORIDE

| | F₂ (volume %) | O₂ (volume %) | Time (seconds) | O via XPS |
|---|---|---|---|---|
| | 0 | 21 | — | 2 |
| 1 | 0.05 | 2 | 2 | 3 |
| 2 | 0.5 | 10 | 2 | 8 |
| 3 | 1 | 10 | 1 | 8 |
| 4 | 5 | 8 | 2 | 11 |
| 5 | 10 | 10 | 1 | 13 |
| 6 | .5 | 0 | 1200 | 2 |
| 7 | 2.5 | 0 | 1200 | 1 |
| 8 | 5 | 10 | 1200 | 12 |

### EXAMPLE 5

The adhesion strength of representatives of three different families of protective coatings were evaluated by applying a thin coat to the variously treated samples, ensuring adequate cure of the coating, and evaluation of adhesion using a variation on ASTM 3359B, the cross hatch test. It was found that the determination of criticality for the surface characteristics required to give excellent adhesion is best performed on monolithic plastic as opposed to WPC composite samples because of complications arising from WPC surface pulling off from some samples and causing cohesive failure to appear like adhesive failure. The specific coatings used were:
Acrylic latex paint=Raykote 2000, made by Drew Paints, Portland Oreg.
Epoxy coating=Ageon 6000 Bis-A 100% Solids Epoxy with Vistamer Rubber; made by Exousia Advanced Materials, Inc., Sugar Land, Tex.
Polyurethane coating=3M Scotchkote 100% solids, plural component Polyurethane Coating System 352; made by 3M Corporation, St. Paul, Minn.

The coatings were applied to the thermoplastic samples each containing one of three thermoplastic compositions: high-density polyethylene [HDPE], polypropylene [PP], and polyvinylchloride [PVC]. The thermoplastic compositions were exposed to surface treatments for each of the material types in accordance with the surface exposures to the respective gases and times described in Tables 8, 9 and 10 for the same materials. The several repeated treatments were performed batch-wise by placing the samples thermoplastic compositions in a small laboratory reactor, pulling a vacuum, and admitting the various gas mixes for the recorded time periods at room temperature, followed by the rapid evacuation of the gases. The results of the adhesion treatment to the thermoplastic surfaces by each of the coatings are shown based on the percent of Oxygen detected following treatment using XPS analysis as set out in TABLES 11A-11C below.

TABLE 11A

| | % O | | | |
|---|---|---|---|---|
| HDPE | (via XPS) | EPOXY | POLYURETHANE | ACRYLIC LATEX |
| Control | 2 | 0B-1B | 0B-1B | 0B-1B |
| Tmt1 | 3 | 0B-1B | 1B-2B | 0B-1B |
| Tmt2 | 8 | 3B-4B | 3B-4B | 2B-3B |
| Tmt3 | 8 | 3B-4B | 4B-5B | 3B-4B |
| Tmt4 | 13 | 4B-5B | 4B-5B | 4B-5B |
| Tmt5 | 14 | 4B-5B | 4B-5B | 4B-5B |
| Tmt6 | 2 | 0B-1B | 1B-2B | 0B-1B |
| Tmt7 | 1 | 0B-1B | 1B-2B | 0B-1B |
| Tmt8 | 16 | 4B-5B | 4B-5B | 4B-5B |

TABLE 11B

| | % O | | | |
|---|---|---|---|---|
| PP | (via XPS) | EPOXY | POLYURETHANE | ACRYLIC LATEX |
| Control | 4 | 0B-1B | 0B-1B | 0B-1B |
| Tmt1 | 4 | 0B-1B | 1B-2B | 0B-1B |
| Tmt2 | 9 | 4B-5B | 4B-5B | 3B-4B |
| Tmt3 | 8 | 4B-5B | 4B-5B | 4B-5B |
| Tmt4 | 15 | 4B-5B | 4B-5B | 4B-5B |
| Tmt5 | 16 | 4B-5B | 4B-5B | 4B-5B |
| Tmt6 | 4 | 0B-1B | 1B-2B | 0B-1B |
| Tmt7 | 4 | 0B-1B | 2B-3B | 0B-1B |
| Tmt8 | 16 | 4B-5B | 4B-5B | 4B-5B |

TABLE 11C

| | % O | | | |
|---|---|---|---|---|
| PVC | (via XPS) | EPOXY | POLYURETHANE | ACRYLIC LATEX |
| Control | 2 | 1B-2B | 1B-2B | 0B-1B |
| Tmt1 | 3 | 1B-2B | 2B-3B | 0B-1B |
| Tmt2 | 8 | 4B-5B | 4B-5B | 4B-5B |
| Tmt3 | 8 | 4B-5B | 4B-5B | 4B-5B |
| Tmt4 | 11 | 4B-5B | 4B-5B | 4B-5B |
| Tmt5 | 13 | 4B-5B | 4B-5B | 4B-5B |
| Tmt6 | 2 | 1B-2B | 1B-2B | 0B-2B |
| Tmt7 | 1 | 1B-2B | 1B-2B | 0B-1B |
| Tmt8 | 12 | 4B-5B | 4B-5B | 4B-5B |

The adhesion of each of the coating following the treatment of the thermoplastic surface areas was measured using the CROSS-HATCH ADHESION TEST—ASTM D 3359 B with the ratings listed in TABLE 12 indicating the strength of the adhesion.

TABLE 12

| | |
|---|---|
| 4B-5B | excellent |
| 3B-4B | good |
| 2B-3B | fair |
| 1B-2B | poor |
| 0B-1B | very poor |

The test results may be interpolated to indicate that the percent of Oxygen in the thermoplastic surfaces of the samples with each of the three thermoplastics should be at least 5 atomic percent, which is the point that surface adhesion begins to increase dramatically, and range up to 18 atomic percent. Further interpolation of the test results of the treatments of the WPC also show that the preferred range for increased adhesion is between 10-18 atomic percent based upon the increased “B” rating that is achieved.

The process contemplates full process integration of the fluoro-oxidation adhesion treatment process and a coating and curing scheme that enables full encapsulation in a single pass up to 1.5 mils at speeds ranging from 50 fpm to >100 fpm. The coatings can be applied via traditional systems such as dip coating, curtain coating, spray coating, vacuum coating or roller-applied systems. Curing of the coating can be from heated air from convection ovens, infrared or UV light. UV cured coatings are preferred due to the high solids, faster line speeds, fast and efficient curing as well as the nonexistence of hazardous volatile organic compounds (VOC's). The oxidized WPC article or profile is then painted or coated with a liquid or solid coating, curing of the paint or coating under conditions that leave the shape and dimensions of the article or profile unchanged.

There are additional attributes of the fluoro-oxidation process that make it ideal for the WPC coatings application. One major attribute is that the surface modification is permanent. There is a small amount of cross-linking at the surface that helps stabilize the oxidation groups from rotating into the first of several molecular layers, which is common with other treatment methods that fade after days or weeks. Another attribute is that the chemistry is extremely rapid in effect. Since the oxidation occurs in less than one second, the process can easily be accomplished in-line, as well as in an off-line manufacturing process. The commercial significance of this capability will be discussed more fully below. Since the process only modifies the outer few molecular layers, there is no visible change in topography. Therefore, any embossed patterning or surface cutouts remain unchanged.

The initial phase of experimentation proved three very important results:
1. The fluoro-oxidation chemistry is rapid and the process window is wide, which means that the process is robust, low cost operation that will not require sophisticated control systems and highly trained personnel;
2. A wide range of commercially available coatings can be utilized on a fluoro-oxidized WPC substrate; and,
3. The technology works well on WPC made from different producers using different polymers, wood flour sources, and additives.

Thus, the fluoro-oxidation process treatment described above can modify the surface of WPC for better adhesion while other known technologies for surface modification of plastics are not effective. Further, the placing of a coating on WPC products, which can only be accomplished effectively using the fluoro-oxidation process treatment, solves the well-known deficiencies in WPC products such as scratch resistance, staining, fading, and mold growth.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A process for performing an oxidative treatment on WPC using fluorine-initiated oxidation such that the oxygen on the surface of the WPC, as measured by XPS, is in the range of 5-18 atomic percent, said process including the application and curing of a protective coating.

2. The process of claim 1, wherein the oxidation process comprises exposing the WPC to a fluorine-initiated oxidation process such that the oxygen content of the surface of the WPC is preferably at least 10 and no greater than 18 atomic percent.

3. The process of claim 1, wherein the fluorine-initiated oxidation treatment is performed in a continuous process.

4. The process of claim 1, wherein the fluorine-initiated oxidation treatment is preformed in a batch process.

5. The process of claim 1, wherein the fluorine concentration is in the range of 0.1-20% by volume, at atmospheric pressure, the temperature for the process is in the range of 0°-90° C. and the exposure time for the process is in the range of 0.1 to 3600 seconds.

6. The process of claim 1, comprising the additional process step of applying the protective coating by vacuum coating.

7. The process of claim 1, comprising the additional process step of applying the protective coating by mechanically applying said coating using one of a group of mechanical applications consisting of roll, brush and spray coating.

8. The process of claim 1, comprising the additional process step of exposing the protective coating to ultra-violet light for curing.
